(19) United States
(12) Patent Application Publication
(10) Pub. No.: US 2021/0125523 A1
(43) Pub. Date: Apr. 29, 2021

(54) SIMULATOR FOR HEARING LOSS PATIENT

(71) Applicant: AHead Simulations Inc., London (CA)

(72) Inventors: Robert KOCH, Kingston (CA); Justin LAING, London (CA); John Enioluwa IYANIWURA, Ottawa (CA)

(21) Appl. No.: 16/666,943

(22) Filed: Oct. 29, 2019

(51) Int. Cl. G09B 23/28; G09B 23/30

(52) U.S. Cl. CPC G09B 23/286; G09B 23/30

(57) ABSTRACT

A system for simulating a patient with hearing loss has an artificial head having at least one through-the-head aperture therein situated where an ear is located on the head, an artificial outer ear made of a first plastic material mountable to the head over the through-the-head aperture, an artificial ear canal made of a flexible second plastic material connectable to the outer ear so that the ear canal extends into the head when the outer ear is mounted on the head, and an imaging device mountable on the head at a position to acquire images of the ear canal in the head when the ear canal is connected to the outer ear and the outer ear is mounted on the head, the second plastic material being transparent to the imaging device so that images of an interior of the ear canal are acquirable by the imaging device.

### FIELD

This application relates to systems and devices for simulating a patient with hearing loss using a manikin-based simulator with in-canal feedback mechanisms.

### BACKGROUND

A system and device that can effectively simulate a patient with hearing loss would be beneficial in both hearing-related research and in training hearing professionals in a number of different procedures. Such a system and device would be useful for training audiologists to fit hearing aids to ears of subjects, ear-maintenance related tasks such as cerumen management, earmold impressions, RIC insertion, deep-canal devices, and the like.

For example, a successful hearing aid fitting is more than just selecting the correct device for a subject's hearing needs. The hearing aid needs to be properly physically and acoustically fitted to the ear to provide the correct amount of amplification to maximize hearing aid benefit.

Prior to a hearing aid fitting appointment, an audiologist/hearing instrument dispenser (clinician) conducts a thorough hearing test to map their patient's range of hearing (audiogram). Based on these tests, the clinician will know how much gain the hearing aid needs to provide at varying frequencies in order for the hearing-loss patient to hear at normal levels. The clinician and patient then typically select a desired style of hearing aid according to their preference and hearing loss. If a closed-fitting is required for the hearing aid or a custom in-ear device is selected, an earmold impression is taken of the outer ear and ear canal to be able to order the hearing aid. Once the hearing aid arrives, the patient returns for a hearing aid fitting.

At the hearing aid fitting appointment, the audiologist will place the hearing aid on the patient and turn on the device to provide amplification to the patient. To ensure the appropriate level of amplification is being delivered to the patient's eardrum, the audiologist verifies that the hearing aid is providing the correct amount of amplification by performing Real Ear Measures. Real Ear Measures allow the clinician to measure sounds directly at the eardrum (with and without amplification through a hearing device). To take these acoustical measurements, a probe with a microphone is inserted into the ear canal so that the microphone is close to the eardrum. Using these measurements, clinicians can fine-tune the hearing aids to meet audiological targets for hearing.

Correct insertion of the probe into the ear canal requires skill and training. If the probe is inserted too far, the probe may impact the eardrum causing harm for the patient. If the probe is not inserted far enough, the Real Ear Measures will not be sufficiently accurate to make educated clinical decisions.

Following the fitting of the hearing aid, the patient may consult with the clinician to troubleshoot or fix any issues with the hearing aid. This may include fine-tuning the settings of the hearing aid or helping with cerumen management (wax removal). Cerumen management is also common for individuals who are currently not using hearing aids.

Cerumen management can be a high-risk procedure with sharp instruments being used within the ear canal to remove this cerumen. An incorrectly performed cerumen management appointment can cause high-levels of harm to patients.

Thus, there is a need for effective systems and devices for simulating a patient with hearing loss. This will help with development of equipment and devices for any stage of the hearing aid prescription process, and for the training of new clinicians to perform all these procedures.

### SUMMARY

There is provided a system for simulating a patient with hearing loss, the system comprising: an artificial head comprising an interior volume and at least one through-the-head aperture between the interior volume and an external environment, the through-the-head aperture situated where an ear is to be located on the head; an artificial outer ear comprising a first plastic material, the outer ear mountable to the head over an exterior end of the through-the-head aperture; a flexible artificial ear canal comprising a flexible second plastic material and having a proximal end and a distal end, the distal end of the ear canal connectable or connected to the outer ear so that the ear canal extends into the interior volume of the head when the outer ear is mounted on the head and the distal end of the ear canal is connected to the outer ear; and, an imaging device mountable on the head at a position to acquire images of the ear canal in the interior volume when the ear canal is connected to the outer ear and the outer ear is mounted on the head, the second plastic material being transparent to the imaging device so that images of an interior of the ear canal are acquirable by the imaging device.

The system and device effectively simulate a patient with hearing loss and are useful in both hearing-related research and training. The system and device are particularly useful for effective training of audiologists for hearing aid fitting, ear-maintenance related tasks such as cerumen management, earmold impressions, receiver-in-canal (RIC) insertions, deep-canal devices, and the like.

The system permits a user to monitor attempts to insert an object into an ear canal in order to learn best practices for such insertions before attempting to undertake such insertions on a living subject. Further, the ‘inside-view’ provides the ability to measure where equipment is located within an ear canal and perform validation and comparisons of different in-ear equipment.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a side view of a system of the present invention in which an artificial ear is removably mounted on an artificial head;

FIG. 2A depicts a top view of an interior volume of the artificial head of the system of FIG. 1;

FIG. 2B depicts a perspective view an interior volume of the artificial head of the system of FIG. 1;

FIG. 3A depicts an isometric view of the artificial head depicted in FIG. 1 in a closed configuration;

FIG. 3B depicts a front view of the artificial head of FIG. 3A;

FIG. 3C depicts a side view of the artificial head of FIG. 3A;

FIG. 4A depicts an isometric view of the artificial head depicted in FIG. 1 in an open configuration;

FIG. 4B depicts a front view of the artificial head of FIG. 4A;

FIG. 4C depicts a side view of the artificial head of FIG. 4A;

FIG. 5A depicts a magnified side view of FIG. 1 showing the artificial ear removably mounted on the artificial head;

FIG. 5B depicts an exploded view of FIG. 5A;

FIG. 6 depicts the artificial ear from FIG. 1 with an artificial ear canal connected to an artificial outer ear;

FIG. 7A depicts a perspective view of an outer side of the artificial outer ear shown in FIG. 6;

FIG. 7B depicts a perspective view of a reverse side of the artificial outer ear of FIG. 7A;

FIG. 8A depicts a front view of the artificial ear canal shown in FIG. 6;

FIG. 8B depicts a rear view of the artificial ear canal shown in FIG. 6;

FIG. 9 depicts the artificial ear canal disconnected from the artificial outer ear of FIG. 6;

FIG. 10A depicts the artificial ear canal of the system of FIG. 1 having an audiology probe inserted therein;

FIG. 10B depicts the artificial ear canal of the system of FIG. 1 having an audiology probe inserted therein, the ear canal having a microphone embedded therein at a proximal end of the ear canal;

FIG. 11A depicts a still image from a video camera mounted in the artificial head of the system of FIG. 1 showing a scale bar and a distal end of the artificial ear canal;

FIG. 11B depicts a still image from a video camera mounted in the artificial head of the system of FIG. 1 showing a scale bar and the distal end of the artificial ear canal with an audiology probe inserted therein;

FIG. 12 depicts a schematic diagram of the system of FIG. 1;

FIG. 13A depicts acoustic results from a system for simulating a patient with hearing loss in which an ear canal is 3D printed from a rigid transparent material (Prototype 3); and,

FIG. 13B depicts acoustic results from a system for simulating a patient with hearing loss in which an ear canal is molded from a flexible transparent material (Final Simulator).

### DETAILED DESCRIPTION

With reference to the Figures, one embodiment of a system 1 for simulating a patient with hearing loss comprises an artificial head 10, two artificial outer ears 20 each removably or non-removably mountable on one or the other side of the head 10, two artificial ear canals 40 each removably or non-removably connectable to one or the other of the outer ears 20, and an imaging device 60 removably or non-removably mountable in an interior volume 11 of the head 10. The system may be modular by using one or more removable elements. Removability permits interchangeability of system elements.

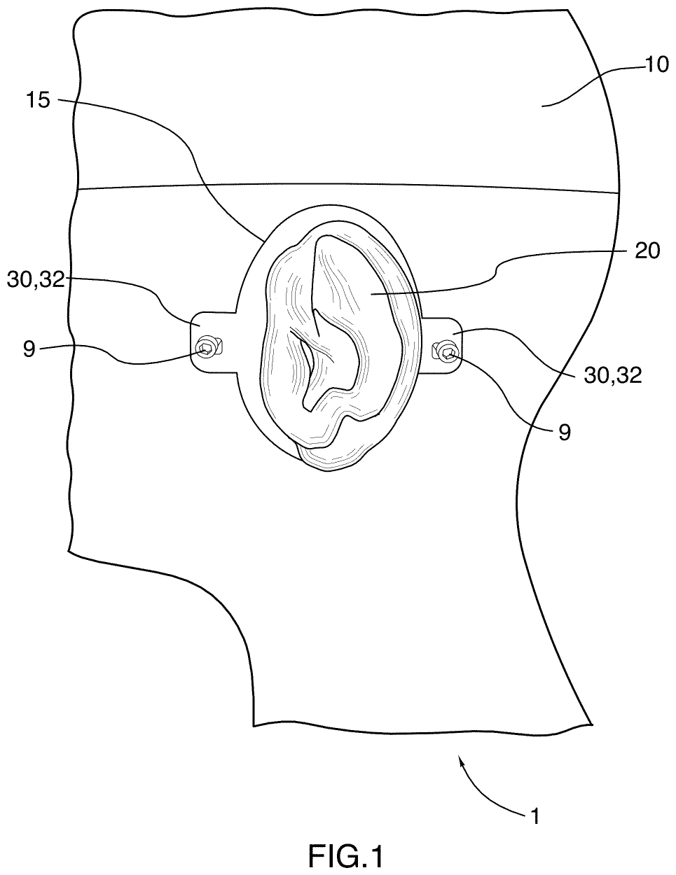

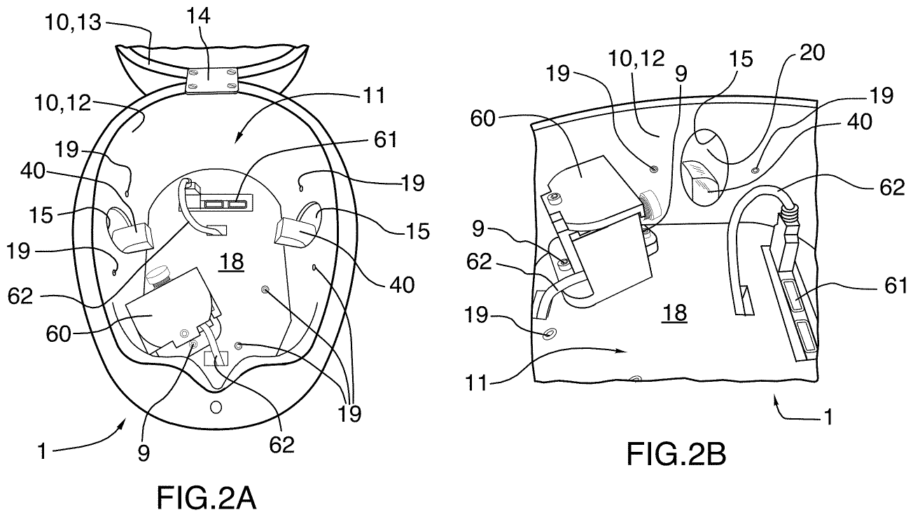

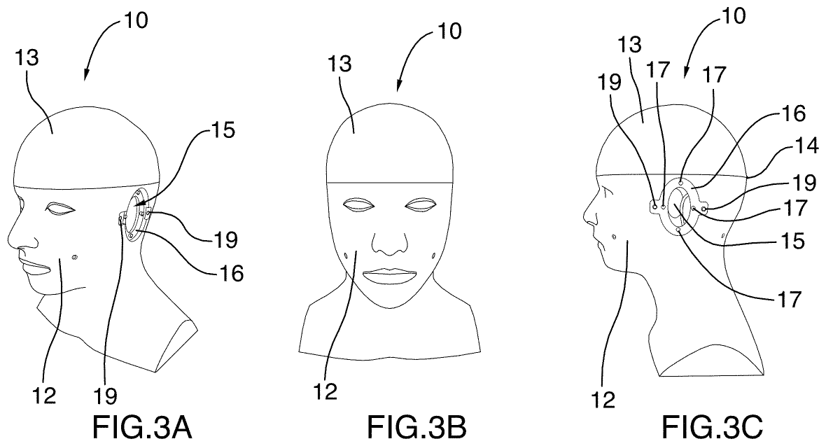

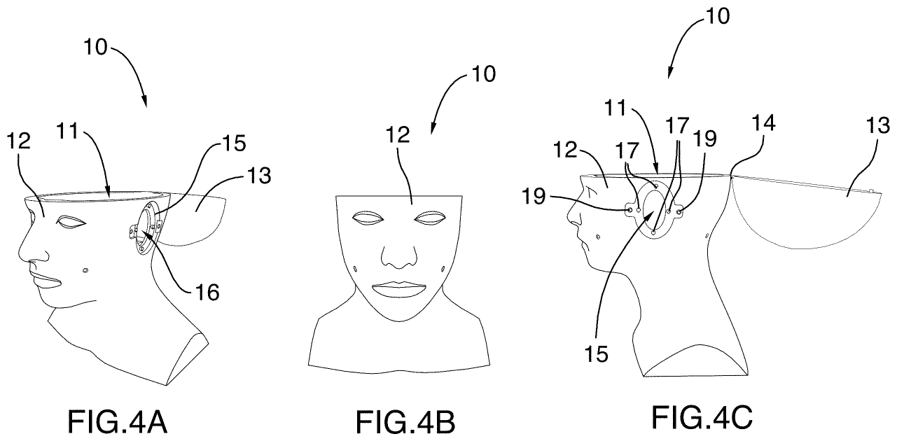

The head 10 is in the shape and size of a typical human head and is constructed of a rigid plastic material by 3D printing techniques such as fused deposition modeling (FDM). Any other suitably rigid material may be used, for example wood, metal, ceramic and the like. A thermoplastic aliphatic polyester, preferably from a renewable resource, for example polylactide (PLA), is preferred. Any other suitable construction technique may be used, for example molding. As best seen in FIG. 3A to FIG. 4C, the head 10 comprises a lower portion 12 and a separable upper portion 13, the upper portion 13 pivotally attached to the lower portion at a hinge 14. The upper portion 13 may be opened as shown in FIG. 2A, FIG. 2B and FIG. 4A to FIG. 4C to permit access to the interior volume 11 of the head 10, or closed as shown in FIG. 1 and FIG. 3A to FIG. 3C during a training session. The head 10 has an interior surface bounding the internal volume 11 of the head 10 and an exterior surface interfacing with the external environment.

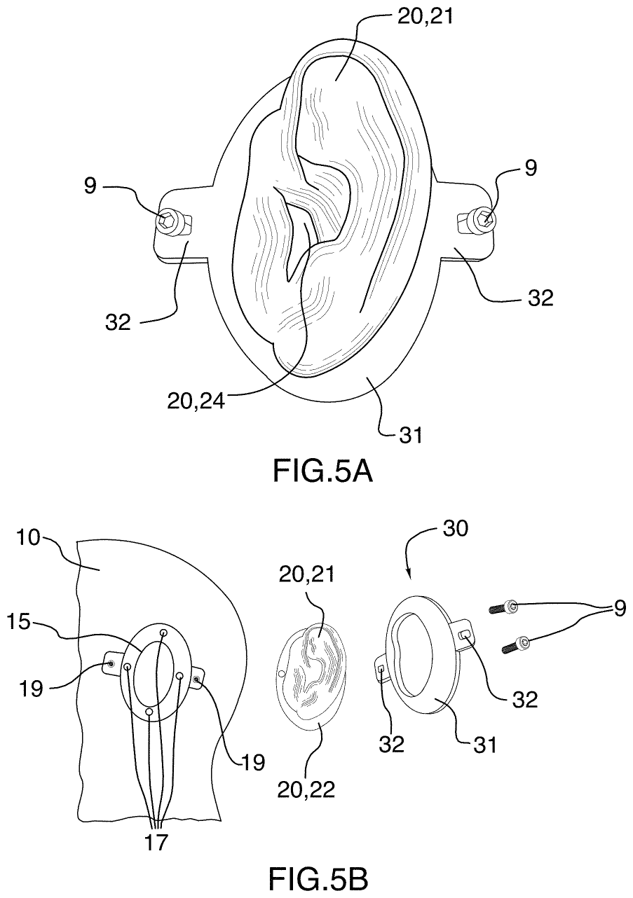

The head 10 comprises two through-the-head apertures 15, one on each side of the head 10 where ears are typically located on a human head. Although two through-the-head apertures are shown, the head may have one or more through-the-head apertures depending on the level of realism desired for the system. The through-the-head apertures 15 extend through the head between the interior volume 11 and an external environment outside the head 10. Annular depressions 16 in the exterior surface of the head 10 around the through-the-head apertures 15 at exterior ends of the through-the-head apertures 15 each have four retaining studs 17 (see FIG. 5B) protruding from the exterior surfaces in the annular depressions 16. While four retaining studs 17 are shown, two or more retaining studs may be used provided the retaining studs can prevent the outer ears 20 from rotating when the outer ears 20 are mounted on the head 10 over the through-the-head apertures 15. The interaction of the retaining studs 17 with the outer ears 20 is described below.

As best seen in FIG. 2A and FIG. 2B, the interior volume 11 of the head 10 is equipped with a mounting platform 18 on which the imaging device 60 is removably mountable together with other electronic components such as power and data outlets 61 and power and data cables 62. Both the mounting platform 18 and the exterior surface of the head 10 have receivers 19 (e.g. nuts) embedded therein, which are used to accept fasteners 9 (e.g. screws or bolts) for removably mounting various components on the head 10. While the fasteners are illustrated as screws and the receivers as nuts, any suitable number and kind of fastener/receiver combinations may be used, for example screws or bolts with mated nuts, push-lock mechanisms (e.g. mated snap-in or click-in mechanisms), mated slide-in mechanisms, hook and loop mechanisms, and the like.

As seen in FIG. 2A and FIG. 2B, the imaging device 60 is removably but rigidly mounted within the head 10 using two of the fasteners 9. The imaging device 60 is held in a consistent and repeatable manner. The imaging device 60 is mountable to acquire images in the interior volume 11 on either side of the head 10 depending on which of the receivers 19 are used to mount the imaging device 60. If the imaging device is small enough, two imaging devices may be mounted inside the head, one to acquire images at a left side and one to acquire images at a right side of the head.

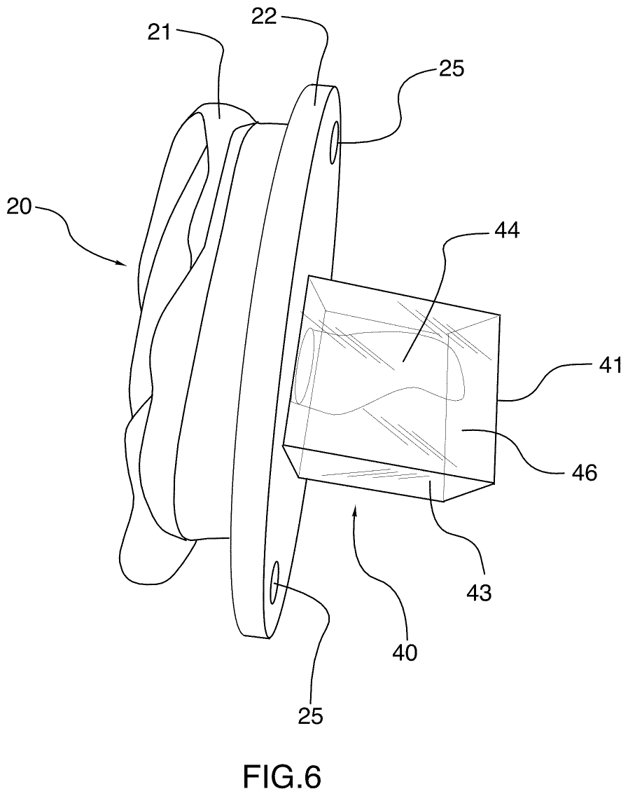

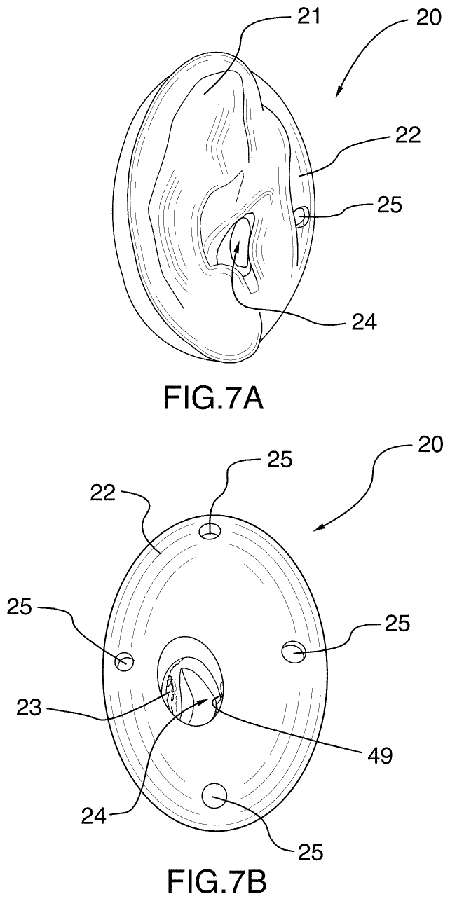

The imaging device 60 is positioned so that an image acquisition path of the imaging device 60 intersects with one of the ear canals 40 at an angle as perpendicular as possible to a flat side 46 (see FIG. 6) of the one ear canal 40 being presented to the imaging device 60. The field of view of the imaging device 60 is preferably wide enough to capture the entire length of the ear canal 40 being imaged, although the field of view should be large enough to at least capture a final 10 mm of the ear canal 40 being imaged.

While the imaging device 60 is shown mountable in the interior volume 11, imaging devices may alternatively, or in addition, be mounted on the exterior surface of the head with the image acquisition path aligned with a hole in the head to be able to acquire images of the interior volume from the outside of the head. Further, In the illustrated system 1, the imaging device 60 is a visible light video camera. However, any suitable imaging device may be employed, for example a camera (e.g. a still camera or a video camera; a visible light camera or an infrared camera), an ultrasound device, or the like.

The outer ears 20 each comprise a shaped portion 21, an outer rim portion 22 attached to a rear of the shaped portion 21 (e.g. by gluing or integrally molding), a receiving aperture 23 in a rear of the outer rim portion 22 for receiving the ear canal 40 and an inner canal portion 24 extending through the shaped portion 21 and outer rim portion 22 to the receiving aperture 23. The inner canal portion 24 is shaped to form a contiguous canal with the ear canal 40 when the ear canal 40 is connected to the outer ear 20. The shaped portion 21 is ear-shaped, having a shape typical for human ears. Because left and right human outer ears have different handedness and because human outer ears are found in a variety of shapes and sizes, it is desirable to have a number of differently handed, shaped and/or sized outer ears for use in the system 1. Because the outer ear 20 is removably mountable on the head 10, the system 1 may comprise a plurality of outer ears having different handedness, shapes and/or sizes. The outer ears are thus interchangeably mountable on the head.

The outer rim portion 22 of the outer ear 20 is designed to engage with the head 10 at the through-the-head aperture 15. The outer rim portion 22 has a size and perimetrical shape to permit seating the outer rim portion 22 on the exterior surface of the head 10 in the annular depression 16 around the through-the-head aperture 15 (see FIG. 5A and FIG. 5B). The outer rim portion 22 comprises four retaining apertures 25 situated around the outer rim portion 22 proximate an outer edge of the outer rim portion 22. The retaining apertures 25 are situated to align with the retaining studs 17 protruding from the exterior surface in the annular depression 16. When the outer rim portion 22 is correctly seated in the annular depression 16, the retaining studs 17 will protrude into the corresponding retaining apertures 25 thereby preventing the outer ear 20 from rotating on the head 10. Two or more retaining apertures may be used provided the retaining apertures in cooperation with the retaining studs can prevent the outer ear 20 from rotating when the outer ear 20 is mounted on the head 10 over the through-the-head aperture 15.

To fasten the outer ear 20 to the head 10 when the outer ear 20 is seated over the through-the-head aperture 15, a connector 30 may be utilized. The connector 30 comprises an annular mounting plate 31 that engages the outer rim portion 22 of the outer ear 20 to secure the outer rim portion 22 against the exterior surface of the head 10 and through which the shaped portion 21 of the outer ear 20 protrudes when the outer ear 20 is mounted on the head 10. The connector 30 further comprises outwardly extending tabs 32 having holes that align with two of the receivers 19 in the head 10 to permit two of the fasteners 9 to removably fasten the connector 30 to the head 10 thereby removably mounting the outer ear 20 on the head 10 (see FIG. 5A and FIG. 5B). Instead of screws and corresponding nuts in screw holes, any other suitable mated pairs of connecting elements may be used, for example push-lock mechanisms, hook-and-loop mechanisms and the like.

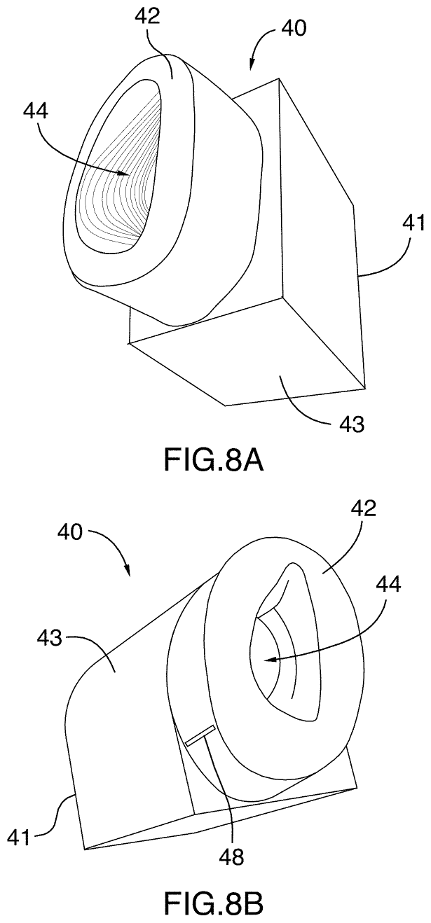

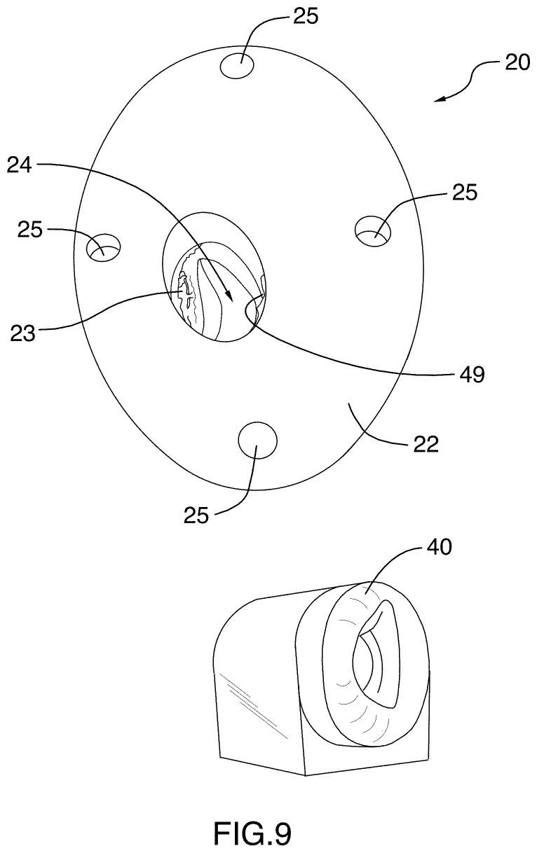

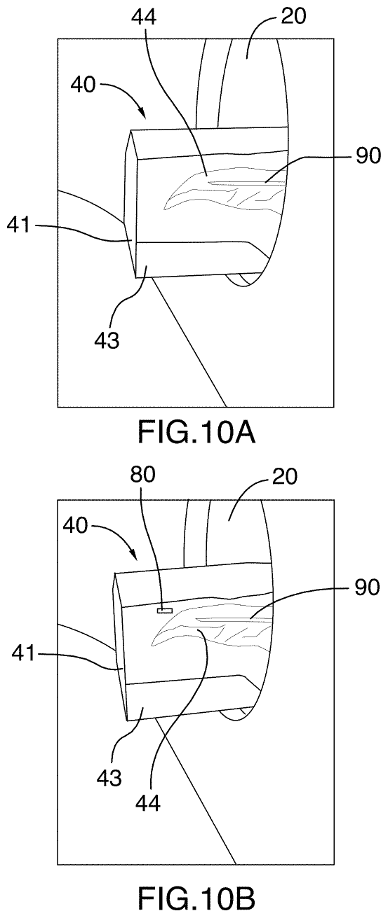

The ear canals 40 each comprise a proximal end 41 and a distal end 42 as best seen in FIG. 6, FIG. 8A, FIG. 8B, FIG. 10A and FIG. 10B. The distal end 42 is connectable to the outer ear 20 so that the ear canal 40 extends into the interior volume 11 of the head 10 when the outer ear 20 is mounted on the head 10 and the distal end 42 of the ear canal 40 is connected to the outer ear 20. The ear canal 40 comprises an outer shell 43 and a lumen 44 passing in the outer shell 43 from the distal end 42 to a position proximate the proximal end 41. The proximal end 41 is closed to simulate the presence of an eardrum. The lumen 44 is shaped and oriented as a typical human ear canal. If desired, the lumen 44 may be formed directly from a computed tomography (CT) scan of a patient to personalize the system to the particular patient. The lumen 44 follows a path through the outer shell 43, which twists up, then back and then forward from the distal end 42 to the proximal end 41 in relation to the head 10, while narrowing from the distal end 42 to the proximal end 41. Such a path offers a twisted path for a device (e.g. a probe, earmold impression material, a deep-seated hearing aid) to follow during insertion of the device into the ear canal 40. Further, flat side 46 of the outer shell 43 forms an oblique angle to a horizontal plane through the outer ear 20, while the flat side 46 is presented to the imaging device 60 so that the angle between the image acquisition path and the flat side 46 is as perpendicular as possible under space constraints in the head 10.

To ensure that both the flat side 46 and the lumen 44 of the ear canal 40 are properly oriented when the ear canal 40 is connected to the outer ear 20 and the outer ear 20 is mounted on the head 10, the receiving aperture 23 in the outer rim portion 22 of the outer ear 20 and the distal end 42 of the ear canal 40 are correspondingly shaped with sufficient irregularity so that the distal end 42 of the ear canal 40 can be fitted only one way into the receiving aperture 23 with close tolerance. An outer perimetrical surface of the distal end 42 of the ear canal 40 and an inner perimetrical surface of the receiving aperture 23 of the outer ear 20 are provided with key elements comprising a corresponding key 48 and keyway 49 to form a keyed-joint between the ear canal 40 and the outer ear 20. The key 48 comprises a longitudinally-extending raised ridge on the outer perimetrical surface of the distal end 42 of the ear canal 40. The keyway 49 comprises parallel spaced-apart longitudinally-extending raised ridges on the inner perimetrical surface of the receiving aperture 23 forming a groove in which the key 48 is seated. The keyed-joint ensures that the ear canal 40 is properly oriented when the ear canal 40 is connected to the outer ear 20. Further, when the ear canal 40 is properly oriented in the outer ear 20, the inner canal portion 24 of the outer ear 20, which extends through the outer ear 20 will be properly aligned with the lumen 44 of the ear canal 40 so that the interior volume 11 of the head 10, the inner canal portion 24 of the outer ear 20 and the lumen 44 of the ear canal 40 are connected to provide a path for insertion of the device. Thus, the receiving aperture 23 and the distal end 42 of the ear canal 40 comprise key elements 48, 49 that form a keyed-joint when the distal end 42 of the ear canal 40 is properly seated in the receiving aperture 23 thereby aligning the inner canal portion 24 of the outer ear 20 with the ear canal 40 and aligning the ear canal 40 in the interior volume 11 of the head 10.

The ear canal 40 may be removably or non-removably connectable to the outer ear 20. For removable connection, the fit between the distal end 42 of the ear canal 40 and the receiving aperture 23 of the outer ear 20 may be a friction fit and the keyed-joint may be sufficiently robust to prevent rotation of the distal end 42 of the ear canal 40 in the receiving aperture 23 of the outer ear 20. To non-removably connect the ear canal 40 to the outer ear 20, the distal end 42 of the ear canal 40 may be bonded into the receiving aperture 23 of the outer ear 20 by an adhesive. To non-removably connect the ear canal 40 to the outer ear 20, the ear canal 40 and outer ear 20 may be molded as a single monolithic piece. Removably and non-removably connectable ear canals can give rise to different ear canal acoustics, all within the realm of patient realism. Whether a removably or non-removably connectable ear canal is desired depends on the application for which the system intended. In all cases, forming an acoustic seal between the outer ear 20 and the ear canal 40 is desirable for being able to produce a realistic acoustic response in the ear.

The outer ear 20 and the ear canal 40 may be fabricated from any suitable material. Preferably, the outer ear 20 is fabricated from a first plastic material and the ear canal 40 is fabricated from a flexible second plastic material. The plastic materials may be any suitable thermoplastic polymers, elastomeric polymers or thermoset polymers. To more closely simulate the feel of a real ear, both the outer ear 20 and the ear canal 40 are preferably fabricated from flexible plastics, for example elastomeric polymers. Silicone elastomers are particularly preferred for both. The outer ear 20 and the ear canal 40 may be fabricated from the same or different material. However, the ear canal 40 must be fabricated from a material that is flexible and is transparent to the imaging device 60 to provide a realistic acoustic response and so that images of the of an interior of the ear canal 40 are acquirable by the imaging device 60.

Fabrication of the outer ear 20 and the ear canal 40 may involve assembling pieces and attaching the pieces together, for example with an adhesive. However, molding is preferred as molding can provide monolithic products and appropriate 2-part molds can be constructed from CT scans of a subject's ears by 3-D printing using fused deposition modeling (FDM) or SLA/SLS 3D printing to provide very realistic replicas of both the outer ear and the era canal. Thus, the outer ear and the ear canal are preferably each molded from the first and second plastic materials, respectively, preferably flexible first and second plastic materials, more preferably first and second silicone materials.

The outer ear 20 is preferably fabricated by molding using Dragon Skin™ 10 SLOW silicone elastomer dyed with silicone pigment to match the intended skin pigment. This silicone is a high-performance platinum cure liquid silicone compound that is used for a variety of applications ranging from creating skin effects and other movie special effects to making production molds for casting a variety of materials. The ear canal 40 is preferably fabricated by molding using SORTA-Clear™ 12 silicone elastomer, which is a premium water white translucent silicone rubber (platinum catalyst) which cures at room temperature with negligible shrinkage. SORTA-Clear™ 12 is sufficiently translucent to allow optical imaging inside the ear canal 40. The ear canal 40 is preferably non-removably connected to the outer ear 20 by coating Sil-Poxy™ adhesive on the distal end 42 of the ear canal 40, inserting the distal end 42 of the ear canal 40 into the receiving aperture 23 of the outer ear 20, and then allowing the adhesive to cure.

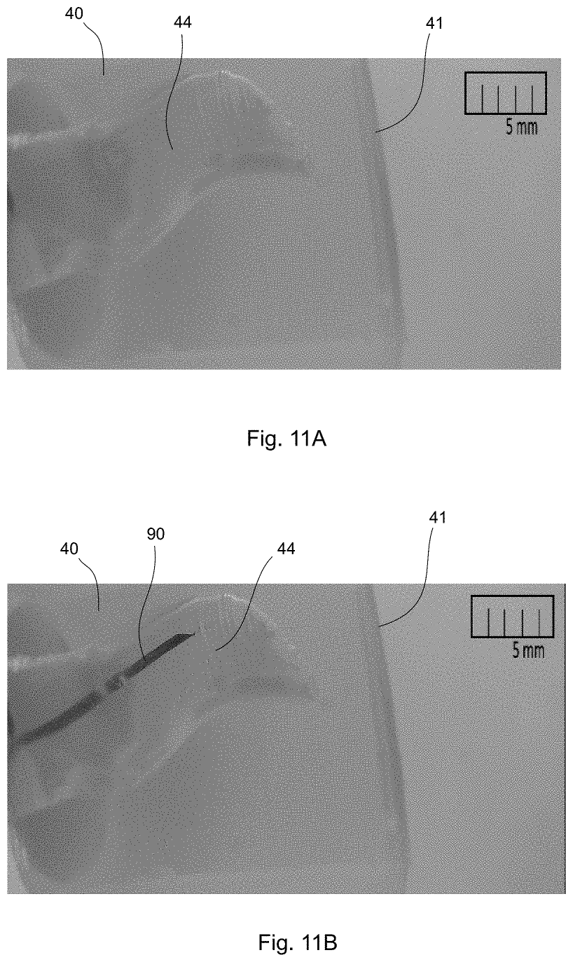

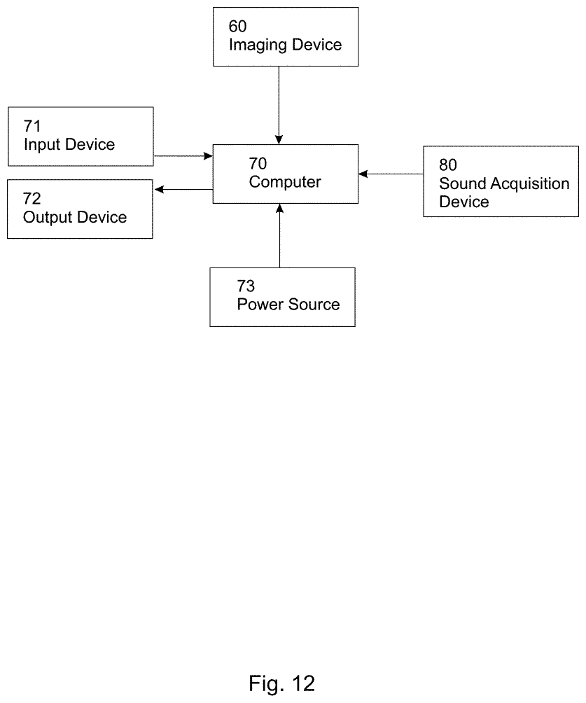

With reference to FIG. 10A, FIG. 10B, FIG. 11A, FIG. 11B and FIG. 12, the system 1 may further comprises at least one data output device 72 (for example a video output device (e.g. a monitor), an audio output device (e.g. a speaker), a printer or the like) in electronic communication with the imaging device 60 for outputting relevant indicia. The at least one data output device may be in direct electronic communication with the imaging device; however, the system 1 preferably further comprises a computer 70 in electronic communication with the imaging device 60 and the data output device 72. The computer 70 may have a non-transient memory programmed with computer executable instructions for handling image data received from the imaging device 60 and outputting the relevant indicia on the output device 72. Furthermore, the system 1 may further comprise a sound acquisition device 80 (e.g. a wired or wireless microphone or the like) for acquiring sounds proximate the proximal end 41 of the ear canal 40. The sound acquisition device 80 may be physically situated proximate the proximal end 41 of ear canal 40, for example by the embedding sound acquisition device 80 in the outer shell 43 of the ear canal 40 during the molding process. To assist with proper placement and retention of the sound acquisition device 80 at the exact desired location, mechanical features may be included in the ear canal 40 that interact with the sound acquisition device 80 to ensure exact placement. Further, an adhesive may be introduced, for example by injection, at the sound acquisition device 80 to acoustically seal the sound acquisition device 80 to the ear canal 40. The system 1 may further comprise an input device (e.g. a keyboard, a mouse, a microphone or the like) to transmit user input to the computer 70, and a power source 73 to power the computer 70 and/or any of the devices 60, 71, 72, 80.

The computer executable instructions programmed into the computer 70 may comprise software that outputs relevant indicia on the output device 72, for example a live image feed of any object that comes within the field of view of the imaging device 60, scale references, warning signals and the like. In some embodiments, warning signals may take the form of visual warnings displayed on a monitor or audible warnings transmitted through a speaker. The software may also track and save the position of the object within the field of view of the imaging device 60. A tracking algorithm may be used that uses common image processing techniques which are implemented via an open-source c++ based library (OpenCV). The frontend, which the user interacts with, may be designed with QML as part of the qt framework.

In one embodiment, the system may be used to practice a fitting procedure. To practice a fitting procedure, the system is prepared by mounting the imaging device 60 in the head 10, and then mounting the assembled ear on the head 10 over one of the through-the-head apertures 15. A user inserts a probe 90 (e.g. a thin probe-tube) through the inner canal portion 24 of the outer ear 20 and keeps inserting the probe 90 into the ear canal 40. The imaging device 60 placed inside the head 10 shows the probe 90 once the probe 90 within the field of view of the imaging device 90 inside the ear canal 40, as shown in FIG. 10A, FIG. 10B, FIG. 11A and FIG. 11B. Additionally, the software can also track the movement of the probe 90 and report to the user the distance of the probe 90 from the proximal end 41 of the ear canal 40, the proximal end 41 of the ear canal 40 simulating the location of the eardrum. An audible warning, for example the word ‘ouch’, may be transmitted through a speaker when the probe 90 contacts the distal end 42 of the ear canal 40, which represents the tympanic membrane.

The probe 90 may be marked to increase contrast so that the probe 90 can be more readily identified in the images acquired by the imaging device 60 (see FIG. 10A to FIG. 11B). The type of marking depends on the type of imaging device used, for example, black pigment can be used for visible light imaging devices, heat sources can be used for infrared cameras, or ultrasound transmitters can be used for ultrasound devices.

The sound acquisition device 80 (e.g. a microphone) embedded in the outer shell 43 of the ear canal 40 can simulate the microphone inserted into a subject in a real hearing aid fitting procedure so that Real Ear Measures can be practiced. The sound acquisition device 80 may also be used to record and listen in real-time to sounds being delivered within the ear canal 40 from devices such as hearing aids. The sound acquisition device 80 may be connected to a sound processing board mounted in the interior volume 11 for real-time processing and analysis of the sound signal. The sound processing board may comprise, for example, raspberry pi, Arduino, Nvidia Nano or the like.

### Examples

Four studies were performed in developing a patient simulator that simulates a hearing loss patient as realistically as possible while having the functionality to provide in-ear canal feedback of objects placed within the ear canal. Development from Study 1 to Study 4 was guided by the desire to create a realistic patient simulator with ears that behave as real ears (e.g. ear canal opens when the back of the ear is pulled up), have a texture like real ears, that look realistic (outside and inside of the ear canal), and that represent acoustics of what a patient may have. Throughout development of the simulator, the method in which in-canal object positioning feedback was provided to the user was improved through more efficient object tracking procedures, better camera positioning, and better ear canal transparency for view from the camera. Further, the patient simulator is desirably portable and easy-to-use within a classroom/lab environment and is low in cost.

### Methods and Materials

The systems used in the studies comprised ear models combined with an optical system for tracking a probe and for measuring the probe's location relative to the Tympanic Membrane™ at the end of the ear canal. Both the ear model and the tracking system were integrated into a head model. The ear model was developed directly from X-ray computed tomography (CT) scans to mimic realistic anatomy. The ear sections were either molded or printed using a Stratasys Objet™ 500 Connex3 3D printer.

The optical tracking subsystem comprised a camera mounted inside the head. For Prototypes 1 and 2, the camera was a Microsoft LifeCam™ HD-3000 camera. For Prototypes 3 and 4, the camera was an ELP 720p USB Camera (ELP-USB100W05MT-BL36-CA). The camera was interfaced with software to analyze objects in the ear canal. The software splits the usage of the system into two modes of operation: practice mode and test mode. The practice mode provides a live camera feed of the ear canal and displays real-time probe-to-TM distance, allowing the user to see exactly how the probe's position inside the ear canal is changing at any time during the insertion. The test mode does not provide real-time feedback, and instead, requires the user to press “start” before the probe is inserted and press “finish” once the probe is in its final position. The users' probe-to-TM distance, time to completion, and a final image of the probe inside the ear canal are displayed after the user has finished. In test mode, live tracking of the probe's position is still occurring but with the results hidden. If at any point the TM is contacted with the probe, a warning sound is outputted to alert the trainee.

Two ear models were created, resulting in two different simulators; one to represent an adult ear and another for a pediatric ear. The ear canal length of the adult model was 32 mm whereas the pediatric ear canal length was 15 mm, as defined by the CT scans. These two anatomies were used to provide a range of variation that may exist between individuals in a clinic. The system using either ear model comprised the same internal components and used the same user interface.

The studies comprised operation and evaluation of the systems with the adult ear model, and operation and evaluation of the systems with the pediatric ear model. Feedback to fine-tune and guide further development and changes were provided by two different kinds of participants, depending on the particular study and experiment that was run. Expert clinicians gave insight to how they had performed procedures on patients in clinic. Several of these clinicians also had experience with teaching these procedures with previous training methods. Novice clinicians with minimal experience were gathered to provide feedback on the simulator as these students would be the ones using the simulator to become comfortable with these procedures before practicing on actual patients.

Depending on the study, participant feedback was received through questionnaires looking at different aspects of the simulator, or through verbal feedback using a “think-aloud” approach (Boren M T, Ramey J. (2000) Thinking aloud: reconciling theory and practice. IEEE Trans Prof Commun 43(3):261-278; and, Brooke R E, Isherwood S, Herbert N C, Raynor D K, Knapp P. (2012) Hearing aid instruction booklets: employing usability testing to determine effectiveness. Am J Audiol 21(2):206-214, the entire contents of both of which are herein incorporated by reference) in which participants were audio- and videotaped to capture their physical use and thought processes while using the system. Questionnaires were created while consulting participants to ensure questions did not produce biases, were accurate, and properly evaluated the audiological components. Questionnaires used in Studies 1 and 2 had their own separate statistical analysis, while all Studies used verbal feedback.

During the study, a given participant was given setup and operating instructions for the specific model to be used. The participant would follow the instructions, which guided the participant through each feature and aspect of the system, including assessing the realism of the ear, otoscopic usage with the system, probe insertion in both practice and test modes, interpretation of results after/during insertion in both practice and test modes, and foam tip insertion. Once the participant was comfortable with the system and had completed the setup and operating instructions, the participant was asked to assess the realism (i.e. the face validity) of specific aspects of the system. Once the face validity was assessed, the participant was required to perform five consecutive probe tube placements in which the final probe-to-TM distance was recorded. Any contacts with the TM were recorded. Finally, once the tasks were performed on both models of the system, the participant assessed the total content validity of the system to find specific facilitators and barriers to implementation of the system in a clinical education setting.

Table 1 highlights the difference in system parameters and acoustic realism results from Study 1 to Study 4 (Prototype 1 to Final Simulator).

TABLE 1

| Parameter | Prototype 1 | Prototype 2 | Prototype 3 | Final Simulator |
|---|---|---|---|---|
| Ear Section | 3 pieces (outer | 3 pieces (outer | 3 pieces (outer | 2 pieces (outer |
| | ear, anterior | ear, anterior | ear, anterior | ear, ear canal) |
| | ear canal, | ear canal, | ear canal, | |
| | posterior ear | posterior ear | posterior ear | |
| | canal | canal | canal | |
| Ear | Outer ear - | Outer ear - | Outer ear - | Outer ear - |
| Composition | Tangoplus ™ | DragonSkin ™ | DragonSkin ™ | DragonSkin ™ |
| | FLX 930 | FX-PRO | FX-PRO | 10 SLOW |
| | Ear canal - | Ear canal - | Ear canal - | Ear canal - |
| | Veroclear ™- | Veroclear ™- | Veroclear ™- | SORTA- |
| | RGD810 | RGD810 | RGD810 | Clear ™ 12 |
| Head | Styrofoam | PC-ABS¹ | PLA² | PLA² |
| Composition | | | | |
| Camera | Styrofoam dug | Camera glued | Camera that | Camera |
| Position | out and camera | to platform | clicks into | fastened to |
| | mounted in | inside 3D | location on | baseplate to |
| | head | printed head | baseplate | increase |
| | | | | repeatability of |
| | | | | camera |
| | | | | location |
| Software | Custom Matlab | OpenCV + Qt | OpenCV + Qt | OpenCV + Qt |
| | | Tracking only | Tracking only | Tracking any |
| | | the probe in the | the probe in the | object in the |
| | | ear canal | ear canal | ear canal |
| Method of | Image | Image | Image | Coordinate |
| Object | subtraction | subtraction | subtraction and | system, |
| Tracking | | | Counting pixels | histogram |
| | | | | calibration and |
| | | | | segmentation |
| Modularity | None | None | Baseplate and | Baseplate and |
| | | | Ears (old, more | Ears (present, |
| | | | difficult, ear | easier, ear |
| | | | attachment) | attachment) |
| Acoustic | No | No | No | Yes |
| Realism | | | | |

¹PC-ABS is polycarbonate-acrylonitrile butadiene styrene.
²PLA is polylactide.

Tangoplus™ FLX 930 is an exo-1,7,7-trimethylbicyclo[2.2.1]hept-2-yl acrylate material. VeroClear™ RGD810 is a rigid, nearly colorless transparent isobornyl acrylate material. DragonSkin™ FX-PRO is a silicone elastomer material having a Shore Hardness of 2A. DragonSkin™ 10 SLOW is a silicone elastomer material having a Shore Hardness of 10A. SORTA-Clear™ 12 is a transparent silicone elastomer material.

### Results

### Study 1:

In Study 1 (Prototype 1), expert clinicians were the participants. All clinicians who participated in Study 1 had a difficult time using the system. 3D printing alone was not yet able to replicate the flexibility and texture of the human ear. The ease of inserting objects into the ear canal, stretching the ear to look into the canal, and the color of the ear were all insufficient for a realistic representation of the ear. In addition, for the object tracking to work properly, there were some issues with the level of transparency of the ear canal, so the ear model and file had to be tuned to simplify the printing process thus increasing transparency of the canal.

Other feedback included: the Styrofoam head model could be more stable and robust; shoulders on the head model for holding equipment and realism would be desirable; acoustical measurements were unrealistic; more than one anatomy available to be swapped in and out would be desirable (i.e. modularity); the software was difficult-to-use; objects in the ear canal were difficult to view due to poor transparency of the ear canal; and, otoscopic view of the canal could be improved.

### Study 2:

For Study 2 (Prototype 2), silicone molding of the outer ear was used instead of direct 3D printing. Further, DragonSkin™ FX-PRO was used for the outer ear instead of Tangoplus™ FLX 930. DragonSkin™ FX-PRO could be used to form outer ears having different stiffness properties. In addition, the head was provided with shoulders, and polycarbonate-acrylonitrile butadiene styrene was used for the head instead of Styrofoam, which made for a more stable head and created a mechanism for swapping ears in and out of the model. The camera for object tracking was mounted on a platform within the head that could be placed correctly within the head for the tracking to work more reliably, and the software for probe tracking was also changed to and OpenCV+Qt platform.

In Study 2, novice clinicians were the participants. The clinicians found that the ear flexed properly, but that the ear canal did not flex with the outer ear. This meant that when a user would pull on the ear to open the canal and insert something within, the ear canal would not open and would not move. The ear canal was fastened to the inside of the head and did not have sufficient range of motion.

Other feedback included: the shoulders were too big, being big on a desk and being unable to fit in a carry-on; the ears came out of the head too easily and were difficult to put back in; both outer ears could be silicone (this model only had one silicone outer ear on only the right side; more than one anatomy available to be swapped in and out would be desirable (i.e. modularity); acoustical measurements in the ear canal were not realistic; and, object-tracking of objects in canal could display strange results due to inaccuracy of tracking algorithm and poor transparency of ear canal.

### Study 3:

For Study 3 (Prototype 3), the head was made slightly smaller and with smaller shoulders, a modular platform was placed within the head to achieve more consistent placement of the camera on the platform and to provide availability to move the camera to look at the opposite ear, and a more secure method of fastening the ear to the head was included.

In Study 3, the participants were expert clinicians interested in using this simulation system within their teaching program. The clinicians found that: the ears could be better secured to the head and improvements could be made to ear replacement capability; the ear canal still did not move and flex sufficiently with the outer ear (the ear canal was 3D printed); acoustical measurements not realistic; the head was tippy requiring redistribution of weight; further calibration of the object-tracking algorithm and camera placement was desirable; and, better product-finish was desirable.

### Study 4:

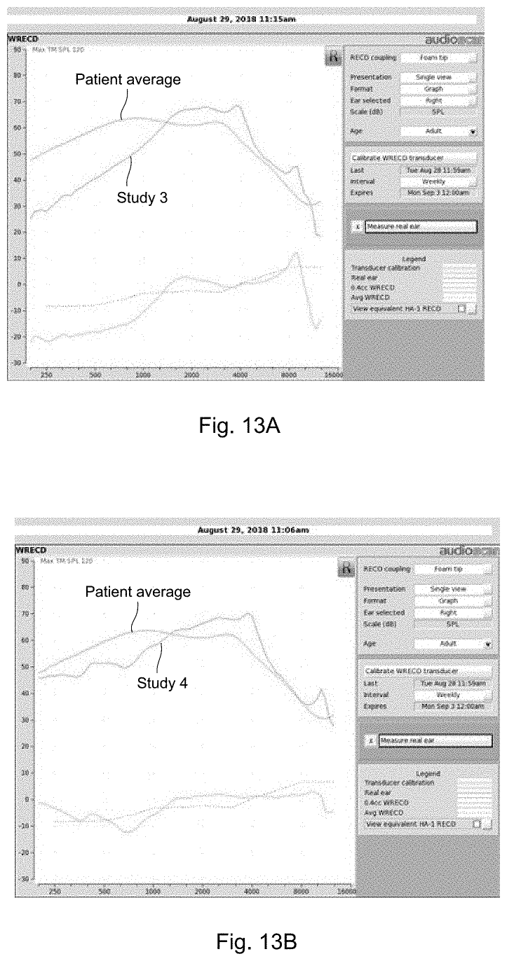

Incorporating all of the feedback from Studies 1 to 3, a final patient simulator (Final Simulator) was developed. For Study 4, the ear canal was now molded from flexible SORTA-Clear™ 12 instead of printed from rigid Veroclear™-RGD810 so that the outer ear and the ear canal would properly flex together. The ear canal was further chemically bonded with outer ear using a silicone adhesive to provide a better acoustic seal. As seen by comparing FIG. 13A to FIG. 13B, the system used in Study 4 (FIG. 13B) provided a better approximation of a patient average (i.e. better acoustic realism) than the system used in Study 3 (FIG. 13A). While the acoustics do not represent a statistically average adult ear canal acoustic, it represents ear canal acoustics within the realm of clinical realism.

The ear was keyed to the head to facilitate swapping the ear in and out of the head. The head model was optimized for better printing. Calibration with a coordinate system was introduced into the software to ensure all tracking is consistent across all sites. A better otoscopic view option was provided by providing a fully one-part skin-colored ear (light and dark) as a swappable option for the head, which is not usable with the camera, but provides a better otoscopic view. Different ear anatomies were made available for the head, although the different anatomies require separate software calibration.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A system for simulating a patient with hearing loss, the system comprising:
an artificial head comprising an interior volume and at least one through-the-head aperture between the interior volume and an external environment, the through-the-head aperture situated where an ear is to be located on the head;
an artificial outer ear comprising a first plastic material, the outer ear mountable to the head over an exterior end of the through-the-head aperture;
a flexible artificial ear canal comprising a flexible second plastic material and having a proximal end and a distal end, the distal end of the ear canal connectable or connected to the outer ear so that the ear canal extends into the interior volume of the head when the outer ear is mounted on the head and the distal end of the ear canal is connected to the outer ear; and,
an imaging device mountable on the head at a position to acquire images of the ear canal in the interior volume when the ear canal is connected to the outer ear and the outer ear is mounted on the head, the second plastic material being transparent to the imaging device so that images of an interior of the ear canal are acquirable by the imaging device.

2. The system of claim 1, wherein the outer ear comprises an inner canal portion extending through the outer ear and a receiving aperture that receives the distal end of the ear canal in a fit to align the inner canal portion of the outer ear with the ear canal and align the ear canal in the interior volume of the head when the ear canal is connected to the outer ear and the outer ear is mounted on the head.

3. The system of claim 2, wherein the receiving aperture and the distal end of the ear canal comprise key elements that form a keyed-joint when the distal end of the ear canal is properly seated in the receiving aperture thereby aligning the inner canal portion of the outer ear with the ear canal and aligning the ear canal in the interior volume of the head.

4. The system of claim 1, wherein the outer ear comprises an ear-shaped portion and an outer rim portion for engagement with the head at the through-the-head aperture, the system further comprising a connector for removably mounting the outer ear on the head over the through-the-head aperture, the connector comprising an annular mounting plate that engages the outer rim portion of the outer ear to secure the outer rim portion against an exterior surface of the head and through which the ear-shaped portion of the outer ear protrudes when the outer ear is mounted on the head.

5. The system of claim 4, wherein the head comprises an annular depression in the exterior surface around the through-the-head aperture, the annular depression having a plurality of retaining studs protruding therefrom, and wherein the outer rim portion of the outer ear comprises a corresponding plurality of retaining apertures in which the plurality of retaining studs are retained when the outer rim portion is seated in the annular depression when the outer ear is mounted on the head, the retaining studs preventing rotation of the outer ear when the outer ear is mounted on the head.

6. The system of claim 1, wherein the first and second plastic materials both comprise silicone elastomers.

7. The system of claim 1, wherein the imaging device comprises a camera.

8. The system of claim 1, wherein the imaging device comprises a video camera.

9. The system of claim 1, wherein the imaging device is mounted in the interior volume of the head.

10. The system of claim 1, wherein the system further comprises at least one data output device in electronic communication with the imaging device for displaying relevant indicia.

11. The system of claim 10, wherein the system further comprises a computer in electronic communication with the imaging device and the data output device, the computer programmed with computer executable instructions for handling image data received from the imaging device and displaying the relevant indicia on the output device.

12. The system of claim 10, wherein at least one data output device comprises an audio output device that provides an audible warning signal when the imaging device detects an object contacting the distal end of the ear canal.

13. The system of claim 1, wherein the ear canal further comprises a sound acquisition device situated proximate the proximal end.

14. The system of claim 13, wherein the sound acquisition device is embedded in an outer shell of the ear canal.

15. The system of claim 13, wherein the sound acquisition device comprises a microphone.

16. The system of claim 13, further comprising a sound processing board mounted in the interior volume of the head for processing sound acquired by the sound acquisition device.

17. The system of claim 1, wherein the head comprises two through-the-head apertures, one on each side of the head.

18. The system of claim 1, wherein at least one other artificial outer ear having a different handedness, shape and/or size than the outer ear and interchangeable with the outer ear.

19. The system of claim 1, wherein the outer ear and the ear canal are each molded from the first and second plastic materials, respectively.

20. The system of claim 1, wherein the system is modular, wherein the outer ear is removably mountable to the head, the ear canal is removably connectable to the outer ear, the imaging device is removably mountable on the head, or two or more thereof are removable.
